(19) United States
(12) Patent Application Publication
(10) Pub. No.: US 2006/0149755 A1
(43) Pub. Date: Jul. 6, 2006

(54) Insertion machine job scheduling systems and methods

(75) Inventors: Todd H. Marshall, Perry, GA (US); Scott J. Smith, Omaha, NE (US); Jeffery G. Nowlin, Council Bluffs, IA (US); Jay E. Greene III, Omaha, NE (US)

Correspondence Address: TOWNSEND AND TOWNSEND AND CREW, LLP, TWO EMBARCADERO CENTER, EIGHTH FLOOR, SAN FRANCISCO, CA, 94111-3834, US

(73) Assignee: First Data Corporation, Englewood, CO (US)

(21) Appl. No.: 11/030,214

(22) Filed: Jan. 5, 2005

(51) Int. Cl. G06F 7/00

(52) U.S. Cl. 707/100

(57) ABSTRACT

Systems and methods are disclosed for scheduling jobs to insertion machines. In one embodiment, the system comprises a communications interface to receive an insertion machine job and a data store to store the insertion machine job and setup information for a plurality of insertion machines, the setup information including job configuration information for jobs scheduled to the insertion machines. Logic is communicatively coupled with the data store and is configured to evaluate each of the insertion machines based at least in part on the setup information and one or more criteria associated with the insertion machine job, to select one of the insertion machines based on the evaluation, and to schedule the insertion machine job to the selected insertion machine.

### BACKGROUND OF THE INVENTION

Insertion machines are used to prepare mailings and sort paperwork. For example, insertion machines may be used to stuff envelopes for customer billings and direct mailings. In some cases, the material in the envelopes is customized for each recipient.

An operator of an insertion machine is responsible for assuring that the envelopes are stuffed with the proper material. Warehouse personnel, sometimes referred to as “stagers”, are responsible for assuring the correct material needed by an insertion machine to perform a job is delivered from the warehouse to insertion machine(s) in a timely manner. Tracking may be performed on the insertion machine and an operator's performance. However, although the job of a stager is crucial to keeping an insertion machine running efficiently, there does not currently exist any mechanism to track and hold stagers accountable for job performance.

Insertion machines may be configured with different setup information to meet the particular needs of an insertion job. For instance, an insertion machine may be configured with a form width, a form length, and whether to print on one side of the stock (simplex) or both sides (duplex). At the conclusion of the current job, the operator of an insertion machine often needs to reconfigure the machine to the requirements of the next job.

Jobs may be manually scheduled to an insertion machine by machine operators. To schedule a job, an operator may view available jobs that are stored in a job database and select a job from the available list to schedule to the operator's insertion machine. In some cases, a supervisor may approve the selected job. The material needed to complete the job is then ordered from the warehouse for delivery to the insertion machine and the operator reconfigures the machine to the job's setup requirements.

### BRIEF SUMMARY OF THE INVENTION

Methods, systems, and machine-readable mediums are disclosed for automatically scheduling jobs to insertion machines for processing. In one embodiment, the method comprises receiving an insertion machine job at a job management system. Setup information for a plurality of insertion machines is obtained. The setup information includes job configuration information for at least a subset of jobs scheduled to the insertion machines (e.g., jobs currently running and/or allocated to the insertion machines). Each of the insertion machines is evaluated at the job management system based at least in part on the setup information and one or more criteria associated with the insertion machine job. The job management system selects one of the insertion machines based on the evaluation and schedules the insertion machine job to the selected insertion machine.

Evaluating each of the insertion machines may comprise calculating a score for each of the insertion machines using the setup information for the respective insertion machine and the one or more criteria. For example, if the setup information for the respective insertion-machine satisfies a criteria, a positive value may be added to the score for the insertion machine. As another example, if a volume scheduled to the respective insertion machine exceeds a threshold value, a negative value may be added to the score for the insertion machine. The calculated score may be used to make the selection of the insertion machine. In some instances, scores may be calculated for each job configuration allocated to the respective insertion machine and the job score with the highest ranking may be selected to use as the score for the respective insertion machine. A tiebreaker criteria may be applied if two or more of the insertion machines have equal scores.

A variety of criteria may be associated with an insertion machine job. The criteria may include a form type, a form width, a form length, and/or a fold type for the insertion job. As other examples, the criteria may include a remittance value indicating a location of a part of a form to be returned to the sender, a print layout, an insert strategy and/or whether the insertion job is simplex or duplex. Other criteria, such as the requesting customer, may also be associated with the insertion machine job and may be used to evaluate which insertion machine to schedule the job.

The method may also further comprise determining a current job for one of the insertion machines is within a predetermined time period of completion and allocating one or more jobs scheduled within a second predetermined time period to the insertion machine. One or more warehouse pick tickets for materials needed by the insertion machine to complete the allocated jobs may also be generated.

In an second embodiment, a method is disclosed which comprises at a job management system, assigning a pick ticket for material needed by an insertion machine to complete a job to a warehouse stager. Input indicating material associated with the pick ticket has been delivered to the insertion machine is received at the job management system. By way of example, receiving the input may comprise receiving a communication from a control system associated with the insertion machine. A status associated with the pick ticket is changed to indicate the pick ticket has been completed.

In some aspects, the method may further comprise providing a user interface to display outstanding pick tickets for one or more insertion machines. The user interface may also display an attribute value for one or more outstanding pick tickets that indicates an assigned warehouse stager responsible for the respective outstanding pick ticket. Another display may be provided to indicate one or more insertion machines having at least one outstanding pick ticket assigned to one of a plurality of warehouse stagers. The second display may also indicate insertion machines waiting for delivery of materials.

In a third embodiment, a system is disclosed which comprises a communications interface, a data store, and logic, communicatively coupled with the data store. The communications interface is configured to receive an insertion machine job. The data store is configured to store the insertion machine job and setup information for a plurality of insertion machines; the setup information including job configuration information for at least a subset of jobs scheduled to the insertion machines. Logic is to evaluate each of the insertion machines based at least in part on the setup information and one or more criteria associated with the insertion machine job, to select one of the insertion machines based on the evaluation, and to schedule the insertion machine job to the selected insertion machine.

The system may also comprise a plurality of control systems, communicatively coupled with the communication interface. Each control system is configured to manage operations for one of the insertion machines and to transmit information for the respective insertion machine to the communications interface. The logic may also be configured to use the tracking information to determine a current job for one of the insertion machines is within a predetermined time period of completion and to allocate one or more jobs scheduled within a second predetermined time period to the insertion machines. Logic may also generate one or more warehouse pick tickets for materials needed by the insertion machine to complete the allocated jobs.

### BRIEF DESCRIPTION OF THE DRAWINGS

Illustrative embodiments in accordance with the invention are illustrated in the drawings in which:

FIG. 1 illustrates an exemplary embodiment of an insertion machine system that may use automatic job scheduling;

FIG. 2 is a block diagram of an exemplary job management system;

FIG. 3 is an exemplary user interface that may be provided by a job management system to display job scheduling information;

FIG. 4 illustrates an exemplary user interface that may be provided by a job management system to display insertion information;

FIG. 5 is an exemplary user interface that may be provided by a job management system to track insertion machine performance;

FIG. 6 illustrates an embodiment of a warehouse user interface;

FIG. 7 illustrates an exemplary job pick ticket;

FIG. 8 illustrates an exemplary user interface that may be provided to track pick tickets;

FIG. 9 is a block diagram of an exemplary computer system upon which a job management system may be implemented;

FIG. 10 is a flow diagram illustrating automatic scheduling of insertion machine jobs;

FIG. 11 is a flow diagram that may be used to automatically allocate jobs to insertion machines; and

FIG. 12 is a flow diagram illustrating an exemplary method that may be used to hold stagers accountable for job performance.

### DETAILED DESCRIPTION

In the following description, for the purposes of explanation, numerous specific details are set forth in order to provide a thorough understanding of the present invention. It will be apparent, however, to one skilled in the art that the present invention may be practiced without some of these specific details. In other instances, well-known structures and devices are shown in block diagram form.

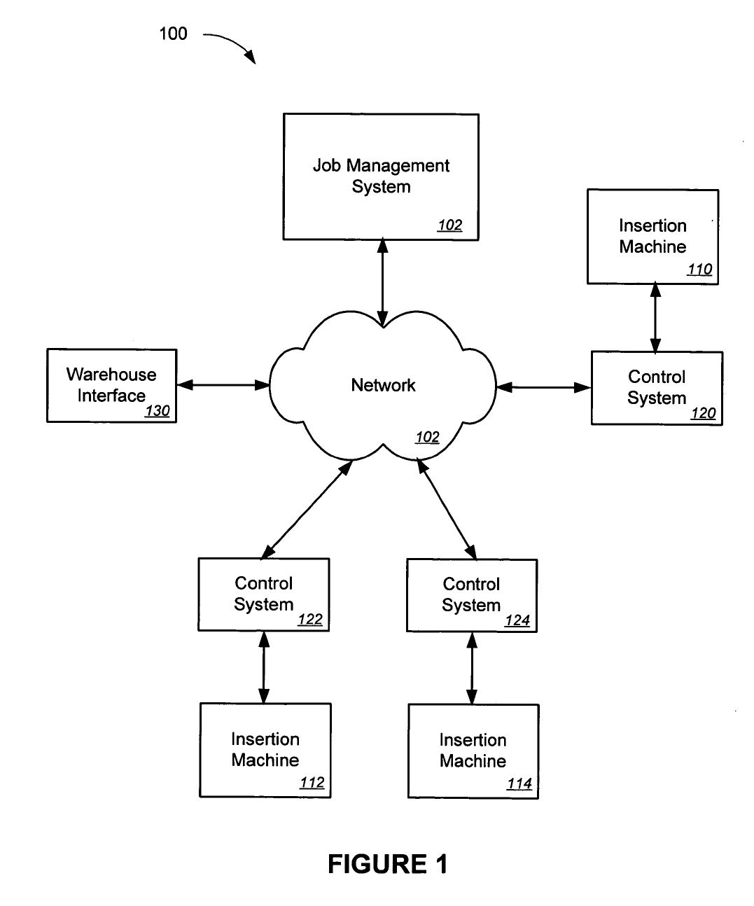

FIG. 1 illustrates an exemplary embodiment of a system that may use automatic job scheduling to schedule insertion machine jobs. The system 100 includes a job management system 102, a plurality of control systems 120, 122, 124, a plurality of insertion machines 110, 112, 114, each associated with one of the control systems 120, 122, 124, and a warehouse interface 130. Job management system 102 communicates with control systems 120, 122, 124 and warehouse interface 130 via network 104. Network 104 may be one or more wired or wireless local area networks (LAN), one or more wired or wireless wide area networks (WAN), the Internet, or other type of network connection(s) that may be used to interconnect job management system 102 with control systems 120, 122, 124 and warehouse interface 130.

Job management system 102 may be used to automatically schedule jobs for insertion machines 110, 112, 114. In some embodiments, job management system 102 may also be used to generate pick tickets for materials needed by an insertion machine to complete allocated jobs and/or to provide pick ticket tracking information via warehouse interface 130. Although FIG. 1 illustrates warehouse interface 130 as a separate component from job management system 102, in some embodiments warehouse interface may be a component of job management system 102 used to display information for warehouse personnel. Exemplary embodiments of job management system 102 and warehouse interface 130 will be described in further detail below.

Insertion machines 110, 112, 114 may be used to collate pieces of printed material into packets, stuff the packets into envelopes, seal the envelopes, meter the envelopes, and/or further imprint the envelopes. Pieces or other material needed by an insertion machine 110, 112, 114 to perform a job may be delivered from a warehouse to the machine by a stager. A machine operator may then load the material into the insertion machine 110, 112, 114. In some embodiments, insertion machines 110, 112, 114 may also perform printing functions to generate printed material.

One exemplary embodiment of an insertion machine 110, 112, 114 is described in U.S. Pat. No. 6,804,576 entitled “Insertion Control”, the details of which are hereby incorporated by reference. In this embodiment, the insertion machines 110, 112, 114 may serially take pieces from a number of piece inserters to form a packet of pieces. Further details may be found in the aforementioned patent. In alternative embodiments, other types of insertion machines 110, 112, 114 may use job management system 102 for job scheduling.

Control systems 120, 122, 124 may each manage operations for one of the insertion machines 110, 112, 114. In some instances, control systems 120, 122, 124 may track counts of pieces, packets, and envelopes and insertion machine configuration (set-up) information. Control systems 120, 122, 124 may also track the movement of their respective insertion machines 110, 112, 114, provide piece-level reporting, and log events. Further functions that may be performed by control systems 120, 122, 124 are described in U.S. Pat. No. 6,804,576, previously incorporated by reference.

Although FIG. 1 illustrates a job management system 102 that is used to perform job scheduling for insertion machines, it should be appreciated that other types of systems and machines may use a job management system 102 to perform job scheduling. For instance, job management system 102 may alternatively or additionally be used to schedule jobs for print systems that may be used to generate printed material for the insertion machines 110, 112, 114.

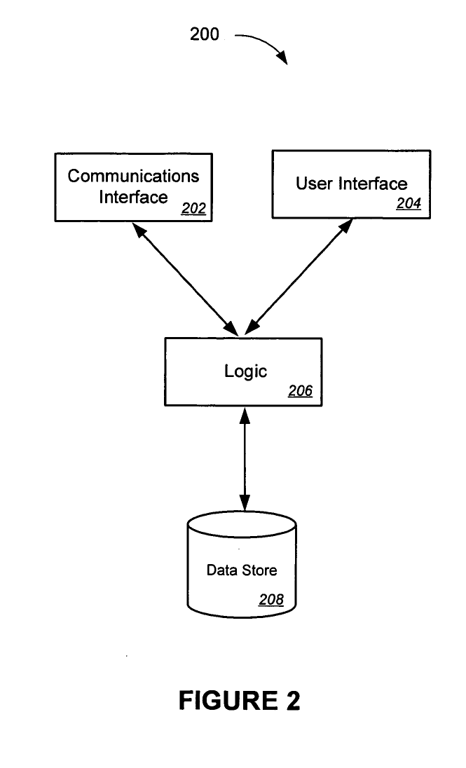

FIG. 2 illustrates an exemplary embodiment of a job management system 200 that may be used to schedule jobs for insertion machines. The job management system 200 may comprise logic 206 communicatively coupled with a communications interface 202, a user interface 204, and a data store 208. A communicative coupling is a coupling that allows communication between the components. This coupling may be by means of a bus, cable, network, wireless mechanism, program code call (e.g., modular or procedural call) or other mechanism that allows communication between the components. Thus, it should be appreciated that logic 206, communications interface 202, user interface 204, and data store 208 may reside on the same or different physical devices.

Communications interface 202 may be used to receive insertion machine jobs to be scheduled to an insertion machine for processing. Thus, communications interface 202 may be coupled with a local area network (LAN), and/or a wide area network (WAN). Alternatively, communications interface 202 may be a peripheral interface coupled with insertion machines over a standard peripheral interface or a proprietary peripheral interface.

Insertion machine jobs may be entered into the job management system 200 using any of a variety of means. For instance, a barcode associated with an insertion job may be scanned and details of the insertion job may be retrieved from a data store and sent to job management system 200 for scheduling. Alternatively, details about an insertion job may be input into the job management system by a user or transmitted from another system. Other means may also be used to indicate insertion machine jobs that are to be scheduled by job management system 200.

A variety of different types of criteria may be associated with the insertion machine job. The criteria may include a form type (e.g., stock number) used by the insertion machine job, a form width, and/or a form length. Other criteria that may be associated with the insertion machine job may include a client number, a remittance value (indicating a portion of the form remitted to the sender, such as a bill coupon), whether the insertion machine job is simplex or duplex, a print layout (e.g., east/west, north/south), a barcode or optical mark recognition code, or a fold type. Other information and criteria, such as a cycle date, a job number, or a job size, may also be associated with the insertion machine job.

The insertion machine job, related criteria and information may be stored in data store 208 for future reference and tracking purposes. Data store 208 may be one or more relational databases, spreadsheet(s), text file(s), internal software list(s), or other type of data structure(s) suitable for storing data. Data store 208 may also store setup information for a plurality of insertion machines. The setup information may include job configuration information for jobs scheduled to the insertion machines. By way of example, the setup information may comprise job configuration information for previously received jobs (including criteria associated with the job) and scheduling information indicating for each job, an insertion machine to which the job has been scheduled. Other information, such as job status information, pick tickets (described further below), customer preference information, and/or tracking/setup information received from control systems associated with insertion machines, may also be stored in data store 208.

Logic 206 may be one or more software programs, one or more components of a software program (e.g., function or program object), firmware, or other type of machine-executable instructions that may be used to schedule insertion machine jobs. The insertion machine jobs may be scheduled by logic 206 based on an evaluation of setup information associated with the insertion machines and criteria associated with the job to be scheduled. In some embodiments, logic 206 may also be used to allocate scheduled jobs to insertion machines and to generate warehouse pick tickets for materials needed by the insertion machines to complete allocated jobs. Further details of the scheduling of insertion machine jobs, allocation of jobs, and generation of pick tickets are described below.

User interface 204 may be used to display scheduling information for the insertion machines. By way of example, user interface 204 may be a graphical user interface displayed on a computer monitor or other type of display device. In some instances, user interface 204 may also be used to display other information or reports related to insertion machines/jobs and/or to receive input from a user (e.g., manual scheduling information, schedule maintenance or downtime for a machine, job information, etc.). In some aspects, user interface 204 may display information on a client computer communicatively coupled with job management system 200 through communications interface 202 or a different communications interface. Further details of information that may be displayed by user interface 204 will be described below.

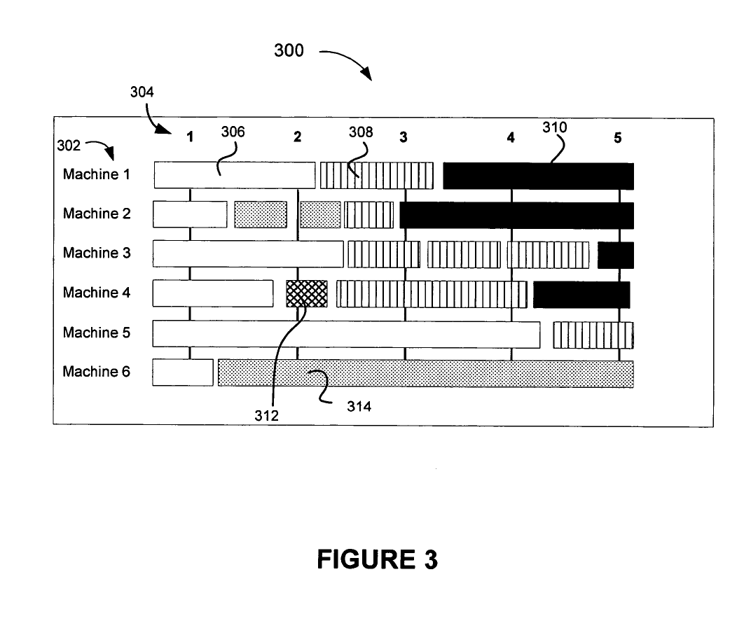

FIG. 3 illustrates an exemplary user interface 300 that may be provided by a job management system to display job scheduling information. User interface includes information for a plurality of rows 302. Each row 302 displays scheduling information for an insertion machine (Machines 1-6). Hours are displayed on a horizontal axis 304. The scheduling information for each machine is indicated by horizontal graphical bars. In alternative embodiments, additional information, such as a job number, may be displayed n conjunction with the graphical bars. Alternatively, the information may be made available in a popup that is displayed when a cursor rests on one of the graphical bars. It should be appreciated that other formats and orientations may also be used to display scheduling information.

In some embodiments, the scheduling information may be displayed in different formats 306, 308, 310, 312, 314, such as different colors or shadings. Each format 306, 308, 310, 312, 314 may indicate a different scheduling status. A first status may indicate an insert job is currently running (displayed as format 306). A second status may indicate that an insert job has been automatically scheduled and allocated to an insertion machine (displayed as format 314). A third status may indicate job that are automatically scheduled to an insertion machine, but not yet allocated (displayed as format 308). As will be described in further detail below, jobs that have been automatically scheduled, but not y et allocated (and in some embodiments, not yet running), may be reshuffled. A fourth status may indicate jobs that have been manually scheduled (displayed as format 312). A fifth status may be used to indicate available scheduling time when a machine is idle (displayed as format 310). In some cases a legend may also be provided in user interface 300 to indicate a mapping between display formats and statuses.

Alternative embodiments may include additional, fewer, or alternative statuses. For example, another status may indicate jobs that have been manually scheduled, but no material has been ordered. In other aspects, job status information may not be displayed. User interface 300 may also display other information, such as groupings of insertion machines. An insertion machine group may be selected for displaying scheduling information, such as shown in FIG. 3. User interface 300 may also allow a user to manually schedule jobs by moving jobs within the interface. Alternatively, a different interface may be provided to allow a user to manually schedule insertion jobs.

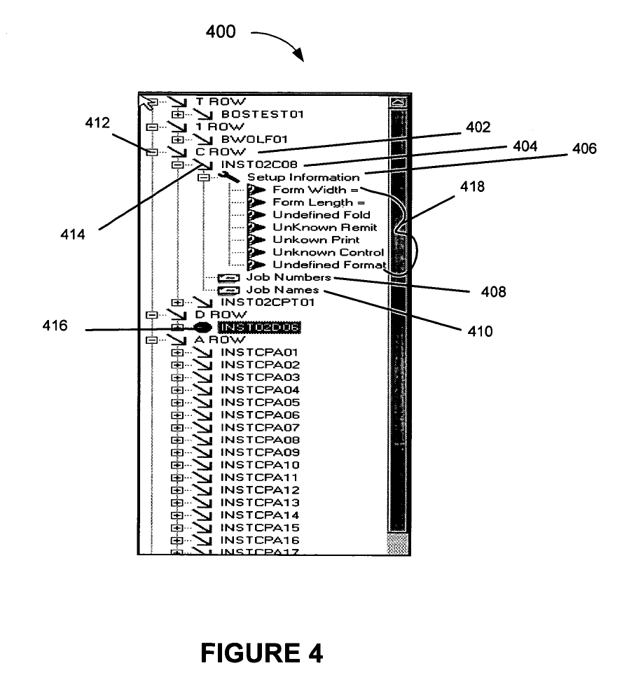

FIG. 4 illustrates a second exemplary user interface 400 that may be provided by a job management system. User interface 400 displays information for a plurality of insertion machines. In this embodiment, insertion machines are grouped in accordance with their physical location, such as C Row 402.

Information about insertion machines is displayed in a hierarchical format. A first level may be used for the groupings of the machines, such as the C Row grouping 402. A user may expand and collapse details of the grouping by selecting mechanism 412. Similar mechanisms may also be provided to expand/collapse other hierarchical levels in display 400.

A second level, underneath the groupings, may be used to display insertion machines contained in the grouping. Insertion Machine 404 is including in the C Row 402. Available categories of information about the insertion machine may be displayed in a third level. In the embodiment of user interface 400, the categories include setup information 406, job numbers 408, and job names 410. Setup information details 418 (displayed as a fourth hierarchical level under setup information 406) may include information on the current setup of the machine 404, such as form width, form length, fold type, remittance type, print type (simplex/duplex), format type, print layout, etc. Job number information 408 may be used to display job numbers scheduled to the insertion machine 404 (and possibly detailed information about job numbers). Job name information 410 may similarly display jobs scheduled to insertion machine 404 by job name. Additional or fewer details about insertion machines may be provided in interface 400.

User interface 400 may also include display mechanisms 414, 416 to visually indicate information about an insertion machine. By way of example, a first mechanism 414 (e.g., green arrow, green light, or any other type of visual indicator) to indicate a machine is available for scheduling. As another example, a second mechanism 416 (e.g., red stop sign, stop sign, red light, or any other type of visual indicator) may indicate a machine is unavailable for scheduling. Different, additional, or fewer visual indicators may also be provided to visually indicate status or other information about an insertion machine.

In some embodiments, interface 400 may be used in conjunction with interface 300 to provide insertion machine information and job scheduling information. For example, interface 400 may be displayed to the left or right of scheduling information 300.

It should be appreciated that a number of variations may be made to user interface 400 to provide information on insertion machines. For instances, insertion machines may not be grouped, or may be grouped by a criteria other than physical location. As another example, the display format of the interface may be different than interface 400 and may not be hierarchical. Other variations are also contemplated.

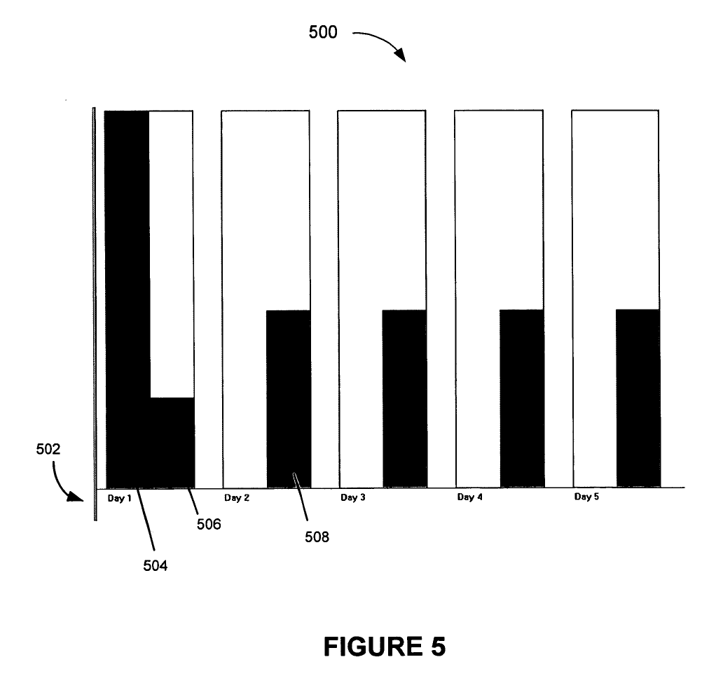

FIG. 5 is an exemplary user interface 500 that may be provided by a job management system to track insertion machine performance. User interface 500 may display performance information for an insertion machine by day 502. The days 502 are displayed along a horizontal axis may indicate the quantity of pieces processed by an insertion machine.

The number of pieces processed may be displayed as vertical bars 504, 506, 508. A job management system may receive information about the number of pieces processed from a control systems associated with insertion machines. If a service level agreement for a day has been met, the graphical bars may be displayed in a first format 508. If a service level agreement has not been met, the graphical bar may be displayed in a second format 506. The expected number of pieces 504 may be displayed adjacent to the number of pieces processed. Other embodiments may display insertion machine performance differently than illustrated in user interface 500.

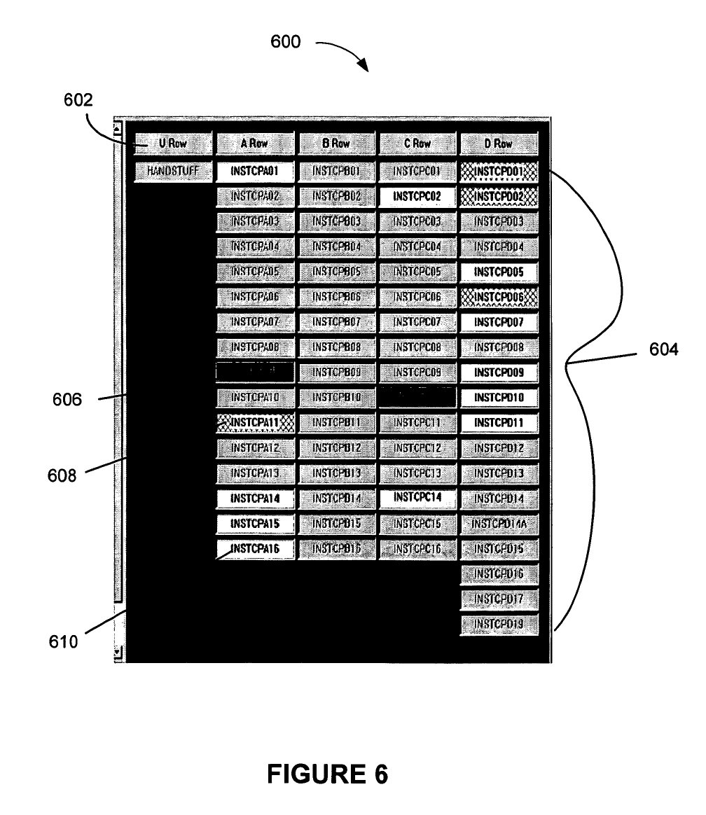

FIG. 6 illustrates an embodiment of a user interface 600 that may be provided to warehouse users. Interface 600 displays insertion machines 604 in rectangular boxes. The insertion machines 604 are grouped in columns in accordance with their physical location. The physical locations are listed as column headers, such as the column header for U Row 602.

Status information about an insertion machine may be visually indicated by changing a background color, fill format, font color or format, or other format of the box used to display an insertion machine. The information may thus visually indicate to a warehouse user (e.g., a stager) insertion machines that have outstanding material orders. For instances, a first format 606 may indicate machines standing idle while waiting for materials. These machines may need the immediate attention of the stager. A second format 608 may indicate machines that have pick tickets for materials needed at an insertion machine which have been assigned to a warehouse stager, but not yet delivered. A third format 610 may indicate pick tickets have been generated for an insertion machine. Other information, such as information indicating a high priority pick ticket is on its way, may also be visually indicated to a warehouse user by stager 600. In alternative embodiments, a warehouse user interface may display information to assist in staging management differently than illustrated in interface 600.

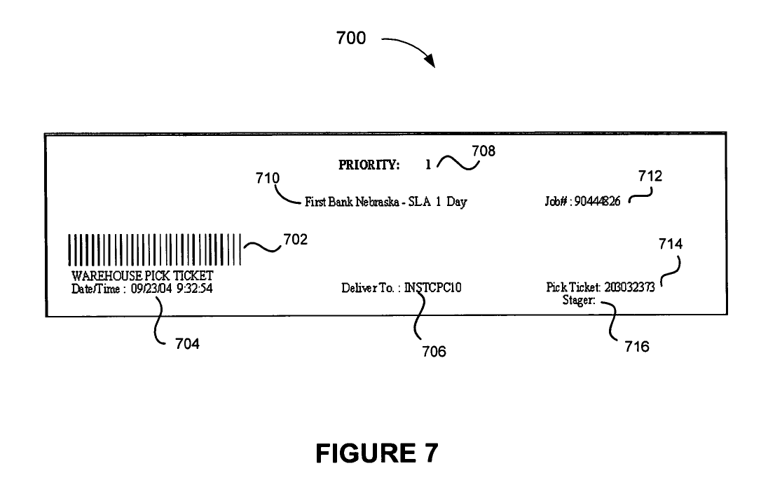

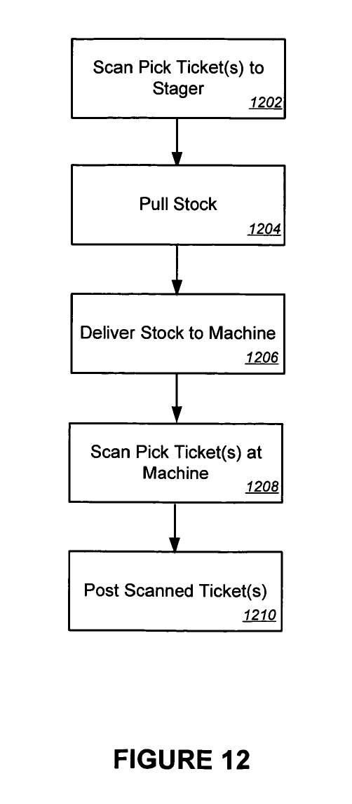

FIG. 7 illustrates an exemplary job pick ticket that may be generated by a job management system to order material delivery to an insertion machine to process an allocated or scheduled job. Pick Ticket 700 includes a bar code 702. Bar code 702 may be scanned by a stager to take responsibility for a pick ticket. Further details are described below with reference to FIG. 12.

The date/time 704 the pick ticket was generated is also included. Pick ticket 700 further includes the machine name 706 to deliver the materials, the priority of the job 708, customer and Service Level Agreement information 710 associated with the job for which the pick ticket was generated, the job number 712, a pick ticket number 714, and an assigned stager 716 (if applicable). In alternative embodiments, a pick ticket may include additional, fewer, or alternative details than pick ticket 700 and the information may be displayed in a different manner.

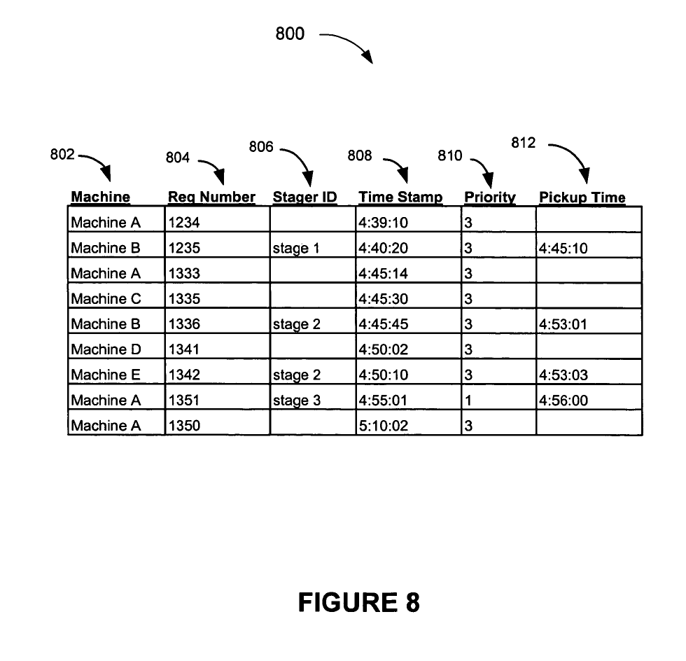

FIG. 8 illustrates an exemplary user interface 800 that may be provided to assist in tracking pick tickets. In this embodiment, pick ticket information is displayed in a table format. Each outstanding pick ticket is displayed as a row in the table. Columns 802-812 indicate attribute information about the pick ticket.

A first column 802 may display the insertion machine associated with the pick ticket. A second column 804 may display the pick ticket number. In a third column 806, a stager responsible for an pick ticket may be indicated. As will be described in more detail with reference to FIG. 12, a stager may take responsibility for a pick ticket by scanning a pick ticket. Thus, there may be outstanding pick tickets which have not yet been assigned. Alternatively, stagers may be pre-assigned to pick tickets.

Other columns may be used to display a time 808 the pick tickets were generated and a priority 810 of the pick ticket. For tickets having a responsible stager, a pickup time 812 may also be displayed. As with the other user interfaces described above, numerous variations may be made to user interface 800 to display additional, alternative, or less information to track and manage pick tickets. Information may also be displayed in a format other than a table.

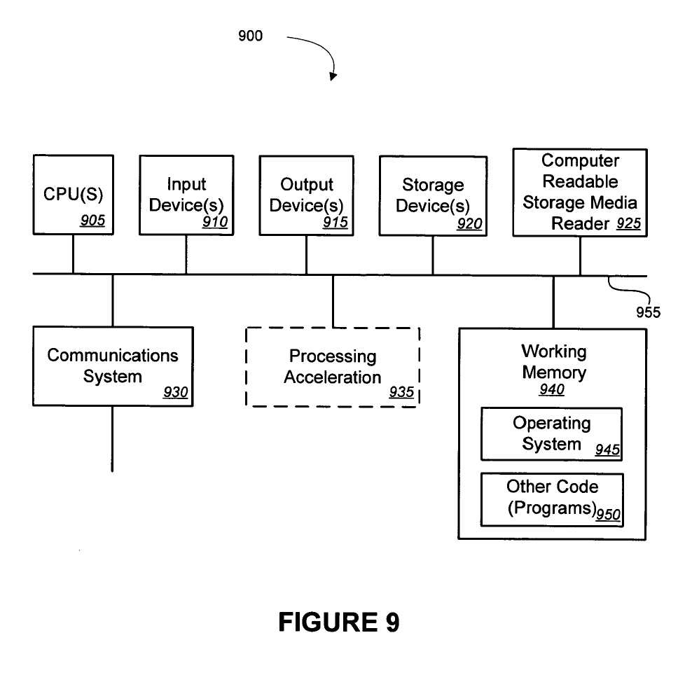

FIG. 9 illustrates one embodiment of a computer system 900 upon which a job management system may be implemented. The computer system 900 is shown comprising hardware elements that may be electrically coupled via a bus 955. The hardware elements may include one or more central processing units (CPUs) 905; one or more input devices 910 (e.g., a scan device, a mouse, a keyboard, etc.); and one or more output devices 915 (e.g., a display device, a printer, etc.). The computer system 900 may also include one or more storage device 920. By way of example, storage device(s) 920 may be disk drives, optical storage devices, solid-state storage device such as a random access memory (“RAM”) and/or a read-only memory (“ROM”), which can be programmable, flash-updateable and/or the like.

The computer system 900 may additionally include a computer-readable storage media reader 925; a communications system 930 (e.g., a modem, a network card (wireless or wired), an infra-red communication device, etc.); and working memory 940, which may include RAM and ROM devices as described above. In some embodiments, the computer system 900 may also include a processing acceleration unit 935, which can include a DSP, a special-purpose processor and/or the like.

The computer-readable storage media reader 925 can further be connected to a computer-readable storage medium, together (and, optionally, in combination with storage device(s) 920) comprehensively representing remote, local, fixed, and/or removable storage devices plus storage media for temporarily and/or more permanently containing computer-readable information. The communications system 930 may permit data to be exchanged with a network and/or any other computer.

The computer system 900 may also comprise software elements, shown as being currently located within a working memory 940, including an operating system 945 and/or other code 950, such as an application program. The application programs may implement a framework, components of a framework, and/or the methods of the invention. It should be appreciate that alternate embodiments of a computer system 900 may have numerous variations from that described above. For example, customized hardware might also be used and/or particular elements might be implemented in hardware, software (including portable software, such as applets), or both. Further, connection to other computing devices such as network input/output devices may be employed.

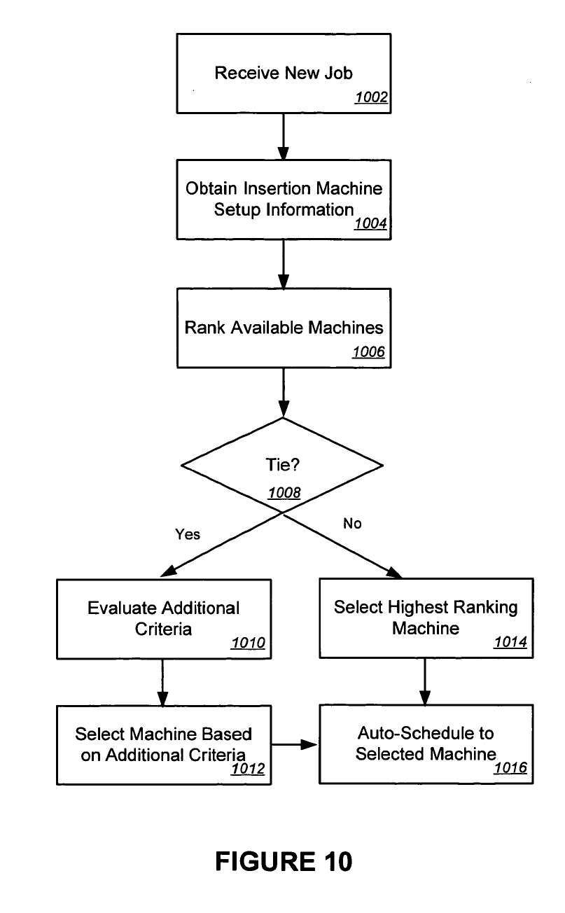

FIG. 10 illustrates an exemplary embodiment of a method that may be used by a job management system to automatically schedule insertion machine jobs. An insertion machine job ready for scheduling may be received 1002. The insertion machine job may be received 1002 from another system (e.g., a print system finished with printing materials), may be manually entered into the job management system, or may be received in another manner. For example, the insertion machine job 1002 may be received by changing a status of a customer job in a data store to indicate the job is ready to be scheduled at an insertion machine. In some aspects, the receipt 1002 of an insertion machine job ready for scheduling may trigger a stored procedure in a database or other process, which initiates a process to automatically schedule the insertion machine job to an insertion machine for processing.

Setup information for a plurality of insertion machines is obtained 1004. By way of example, setup information may be obtained 1004 from a data store associated with job management system. In some cases, some of the information may be periodically transmitted to the job management system or otherwise obtained from control systems associated with the job management system.

The setup information includes job configuration information for at least a subset of jobs scheduled to the insertion machine jobs. The job configuration information specifying the insertion machine setups used to process the jobs. In one embodiment, setup information may be obtained 1004 for all jobs currently scheduled or running on the insertion machines. In alternate embodiments, setup information may be obtained for a subset of jobs scheduled to the insertion machines, such for as the jobs currently running or allocated, the last job scheduled to the insertion machine, or other subset. If an insertion machine does not have any currently scheduled jobs, the current configuration of the insertion machine may be included in the setup information.

The insertion machine job to be scheduled may include one or more criteria specifying an insertion machine setup needed to process the job. The criteria may include a form type, a form width, a form length, a remittance value indicating a portion of the form remitted to the sender (e.g., top, bottom), a print format (simplex/duplex), print layout (e.g., east/west, north/south), barcode or optical mark recognition requirements, an insert strategy, a fold type, or other criteria. This criteria may be used by the job management system to evaluate the insertion machines based on the setup information to determine which machine to schedule the insertion machine job. In some aspects, each of the-job configurations included in the setup information (i.e., all currently scheduled jobs or subset of jobs) may be evaluated separately to determine whether the job configuration satisfies criteria needed by the insertion machine job to be scheduled.

In one embodiment, the job management system may rank 1006 each insertion machine to determine where to schedule the insertion machine job. According to one aspect, the job management system may rank 1006 the insertion machines by a calculating one or more scores for each insertion machine using the setup information and the criteria for the insertion machine job. In some instances, a score may be calculated for each job configuration included in the setup information and the highest calculation may be taken for each insertion machine and used to rank 1006 the available machines. A positive point value may be assigned if the setup matches the criteria. Alternatively or additionally, a negative point value may be assigned if the setup does not match the criteria. One or more of the criteria used in the calculation may be weighted in accordance with its importance. For example, criteria that are more important (which may be related to job priority or difficulty in reconfiguring the machine) may be given a greater weight in the calculation.

Other criteria may also be used in the calculation. One example may be if a volume on an insertion machine exceeds a threshold value, a negative value may be added to the calculation(s) for the machine. In some instances, the comparison to the threshold value may involve a physical volume and time calculation which uses physical characteristics of the job setup, number of pages, and inserts to calculate an amount of time for the insertion machine to complete the scheduled volume. As another example, a positive score may be added to the calculation(s) for an insertion machine if the machine is the preferred machine for the client associated with the job. As a third example, a positive score may be assigned to calculations associated with previously scheduled jobs for the same client as the insertion machine job to be scheduled. Alternative, additional, or fewer criteria may be used to calculate scores for insertion machines or otherwise evaluate the insertion machines.

If 1008 one or more of the machines are equally ranked for first place (e.g., the calculated values for the insertion machines are equal), additional criteria may be evaluated 1010 to break the tie. By way of example, the tiebreaker criteria may comprise the volume level of the insertion machines. One of the equally ranked insertion machines may be selected 1012 based on the tiebreaker criteria. For example, in the case of a tie, the insertion machine with the lowest volume may be selected to process the insertion machine job. If 1008 there is not a tie for first place, the highest ranked machine may be selected 1014 to process the insertion machine job.

The insertion machine job may then be automatically scheduled 1016 to the selected insertion machine. In some embodiments, the amount of time scheduled 1016 for the job may be calculated based on the amount of time associated with each of one or more of the characteristics of the job setup and the volume (e.g., number of pages/inserts). The insertion machine job may be scheduled 1016 at the end of the currently scheduled jobs. Alternatively, some or all of the jobs scheduled on the insertion machine may be bumped to a later time. For example, all jobs scheduled, but not currently running, may be prioritized by service level agreement. Jobs having the same priority level, may be scheduled in order of cycle date, job size, and/or sequential job number. In alternative embodiments, only a subset of jobs may be reshuffled (e.g., allocated jobs (jobs for which materials have not yet been ordered from the warehouse)), the job may be scheduled 1016 to the insertion machine after the job having the configuration closest matching the setup needed by the job to be scheduled, or other scheduling location.

Variations may be made to the method described above to automatically schedule an insertion machine job to an insertion machine for processing. Additionally, the method may be triggered by events other than the receipt of a new job ready for scheduling. For example, in the event an insertion machine becomes unavailable, the insertion machine jobs currently scheduled to the unavailable machine may be automatically rescheduled using a process similar to that described above.

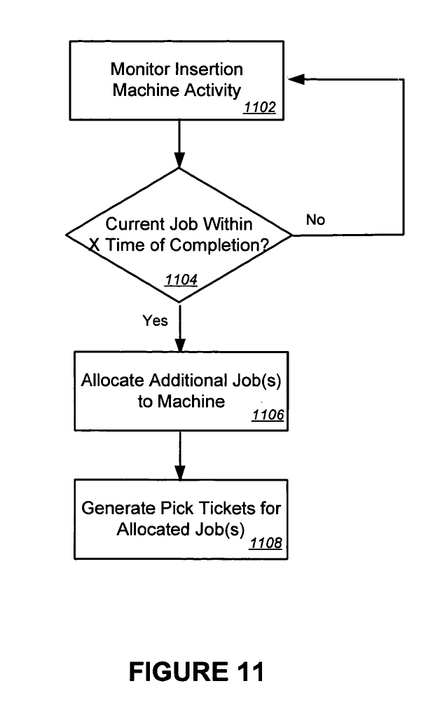

FIG. 11 illustrates an exemplary method may be used to automatically allocate jobs to insertion machines. In order to process an insertion machine job, the material (pieces) associated with the insertion job need to be delivered to the insertion machine. The job management system may monitor 1102 insertion machine activity to determine when to order the material for future jobs. By way of example, the job management system may periodically poll control systems associated with the insertion machines to determine how many pieces of the job currently running have been processed. Alternatively, the control systems may push this information to the job management system at periodic intervals or at predetermined times (e.g., when a number of pieces to be processed is less than a threshold).

Based on the machine activity information, the job management system may make a determination 1102 whether currently running jobs are within a first predetermined time period (e.g., 1 hour) of completion. If the job management system determines there are not any insertion machines within the first predetermined time period of completing the currently running jobs, the job management system may continue to monitor 1102 the insertion machine activity.

If an insertion machine job is within the first predetermined time period of completion, one or more additional jobs that are scheduled to the insertion machine may be allocated 1106 to the insertion machine. In one embodiment, the job management system may allocate 1106 jobs scheduled within a second predetermined time period (e.g., 3 hours). Pick tickets ordering the materials needed for the allocated jobs may also be generated 1108 by job management system.

In alternative embodiments, the method of allocating insertion machine jobs and ordering materials delivered to insertion machines may be performed differently. For example, criteria in addition to or instead of time (e.g., piece count) may be used to determine when to allocate jobs. Other variations are also contemplated.

FIG. 12 is a flow diagram illustrating an exemplary method that may be used to hold stagers accountable for job performance. A job management system may assign pick tickets to a particular stager. The assigned stager then becomes responsible for delivering materials associated with the pick ticket to the insertion machine needing the materials. In one embodiment, the stager may become responsible for a pick ticket by scanning 1202 the pick ticket to the stager. Alternatively, the stager may be pre-assigned by the job management system.

The stager may then pull 1202 the stock from the warehouse specified by the assigned pick ticket and deliver 1206 the stock to the insertion machine. The stager may then provide input to the job management system that the material has been delivered. For example, the stager may scan 1208 the pick ticket at a control system associated with the machine, which may then provide that information to the job management system. Alternatively, an interface to the job management system may be included as part of the control system so that the stager may directly input (via scan or other means) information indicating the material has been delivered.

The job management system may then post 1210 the scanned tickets to change the status associated with the pick ticket to indicate the pick ticket has been completed. As previously described, user interfaces may be provided to help manage outstanding pick tickets. It should be appreciated that the process described in FIG. 12 may be used to hold warehouse stagers accountable for material delivery.

In the foregoing description, for the purposes of illustration, methods were described in a particular order. It should be appreciated that in alternate embodiments, the methods may be performed in a different order than that described. Additionally, the methods may contain additional or fewer steps than described above. It should also be appreciated that the methods described above may be performed by hardware components or may be embodied in sequences of machine-executable instructions, which may be used to cause a machine, such as a general-purpose or special-purpose processor or logic circuits programmed with the instructions, to perform the methods. These machine-executable instructions may be stored on one or more machine readable mediums, such as CD-ROMs or other type of optical disks, floppy diskettes, ROMs, RAMs, EPROMs, EEPROMs, magnetic or optical cards, flash memory, or other types of machine-readable mediums suitable for storing electronic instructions. Alternatively, the methods may be performed by a combination of hardware and software.

While illustrative and presently preferred embodiments of the invention have been described in detail herein, it is to be understood that the inventive concepts may be otherwise variously embodied and employed, and that the appended claims are intended to be construed to include such variations, except as limited by the prior art.

What is claimed is:

1. A method comprising:
receiving, at a job management system, an insertion machine job;
obtaining setup information for a plurality of insertion machines, the setup information including job configuration information for at least a subset of jobs scheduled to the insertion machines;,
evaluating, at the job management system, each of the insertion machines based at least in part on the setup information and one or more criteria associated with the insertion machine job;
selecting, with the job management system, one of the insertion machine based on the evaluation; and
scheduling, with the job management system, the insertion machine job to the selected insertion machine.

2. The method of claim 1, wherein evaluating each of the insertion machines comprises for each of the insertion machines, calculating a score using the setup information for the respective insertion machine and the one or more criteria.

3. The method of claim 2, wherein calculating the score comprises for one or more of the criteria, if the setup information for the respective insertion machine satisfies the respective criteria, adding a positive value to the score.

4. The method of claim 3, further comprising if a volume scheduled to the respective insertion machine exceeds a threshold value, adding a negative value to the score.

5. The method of claim 2, wherein selecting one of the insertion machines comprises using the calculated scores to select the insertion machine.

6. The method of claim 2, wherein evaluating each of the insertion machines comprises applying a tiebreaker criteria to at least two of the insertion machines having equal scores.

7. The method of claim 2, wherein calculating the score comprises calculating a job score for each job configuration allocated to the respective insertion machine and selecting the job score with a highest ranking for the respective insertion machine.

8. The method of claim 1, wherein obtaining the setup information comprises obtaining setup information for each job allocated to each of the insertion machines.

9. The method of claim 8, wherein evaluating each of the insertion machines comprises for each of the insertion machines, evaluating the job configuration information for each job allocated to the insertion machine using the one or more criteria.

10. The method of claim 1, wherein the criteria include one or more of a form type, a form width, a form length, and a fold type.

11. The method of claim 1, wherein the criteria include one or more of a remittance value, a print layout, an insert strategy, and a value indicating whether the job is simplex or duplex.

12. The method of claim 1, further comprising:
receiving an indication one of the insertion machines is unavailable; and
for each job scheduled to the unavailable insertion machine, repeating the obtaining the setup information, the evaluating, the selecting, and the scheduling.

13. The method of claim 1, further comprising:
determining, with the job management system, a current job for a first one of the insertion machines is within a predetermined time period of completion; and
allocating one or more jobs scheduled within a second predetermined time period to the first insertion machine.

14. The method of claim 13, further comprising generating one or more warehouse pick tickets for materials needed by the first insertion machine to complete the allocated jobs.

15. A method comprising:
at a job management system, assigning a pick ticket for material needed by an insertion machine to complete a job to a warehouse stager;
receiving, at the job management system, input indicating material associated with the pick ticket has been delivered to the insertion machine; and
changing a status associated with the pick ticket to indicate the pick ticket has been completed.

16. The method of claim 15, further comprising providing a user interface displaying outstanding pick tickets for one or more insertion machines.

17. The method of claim 16, further comprising displaying, in the user interface, an attribute value for one or more of the outstanding pick tickets indicting an assigned warehouse stager responsible for the respective pick ticket.

18. The method of claim 15, wherein receiving input indicating material associated with the pick ticket has been delivered to the insertion machine comprises receiving a communication from a control system associated with the insertion machine.

19. The method of claim 15, further comprising providing a user interface displaying a plurality of insertion machines, the display indicating one or more of the insertion machines having at least one outstanding pick ticket assigned to one of a plurality of warehouse stagers.

20. The method of claim 19, wherein the display further indicates a second set of insertion machines waiting for delivery of materials.

21. A system comprising:
a communications interface, to receive an insertion machine job;
a data store to store the insertion machine job and setup information for a plurality of insertion machines, the setup information including job configuration information for at least a subset of jobs scheduled to the insertion machines; and
logic, communicatively coupled with the data store, to evaluate each of the insertion machines based at least in part on the setup information and one or more criteria associated with the insertion machine job, to select one of the insertion machines based on the evaluation and to schedule the insertion machine job to the selected insertion machine.

22. The system of claim 21, further comprising a plurality of control systems, communicatively coupled with the communication interface, each control system configured to manage operations for one of the insertion machines and to transmit tracking information for the respective insertion machine to the communications interface.

23. The system of claim 22, wherein the logic is further configured to use the tracking information to determine a current job for one of the insertion machines is within a predetermined time period of completion and to allocate one or more jobs scheduled within a second predetermined time period to the insertion machine.

24. The system of claim 23, wherein the logic is further to generate one or more warehouse pick tickets for materials needed by the insertion machine to complete the allocated jobs.

25. The system of claim 24, further comprising a warehouse interface, communicatively coupled with the data store, to display outstanding pick tickets for the insertion machines.

26. The system of claim 22, further comprising the insertion machines, each insertion machine communicatively coupled with one of the control systems.

27. The system of claim 21, further comprising a user interface to display scheduling information for the plurality of insertion machines.
